(19) United States
(12) Patent Application Publication
(10) Pub. No.: US 2020/0377368 A1
(43) Pub. Date: Dec. 3, 2020

(54) PARTICLE MIXTURE, METHOD FOR ENHANCING LIGHT SCATTERING USING SAME, AND LIGHT-SCATTERING MEMBER AND OPTICAL DEVICE INCLUDING SAME

(71) Applicant: Mitsui Mining & Smelting Co., Ltd., Tokyo (JP)

(72) Inventors: Yoshihiro YONEDA, Ageo (JP); Kazuhiko KATO, Ageo (JP)

(21) Appl. No.: 16/769,307

(22) PCT Filed: Dec. 5, 2018
(86) PCT No.: PCT/JP2018/044753

§ 371 Date: Jun. 3, 2020

(30) Foreign Application Priority Data
Dec. 21, 2017 (JP) 2017-245605

(51) Int. Cl. C01B 25/37; C08K 3/32; G02B 5/02; C08K 3/24

(52) U.S. Cl. CPC C01B 25/37; C08K 3/24; G02B 5/0205; C08K 3/32

(57) ABSTRACT

A particle mixture containing a particle A and a particle B different from the particle A. The particle A is a particle of a rare earth phosphate represented by LnPO₄ wherein Ln represents at least one rare earth element selected from the group consisting of Sc, Y, La, Eu, Gd, Dy, Yb, and Lu. The particle B is a particle of a rare earth phosphate represented by LnPO₄ wherein Ln represents at least one rare earth element selected from the group consisting of Sc, Y, La, Eu, Gd, Dy, Yb, and Lu, or a rare earth titanate particle.

### CROSS REFERENCE TO RELATED APPLICATIONS

This application is a U.S. National Stage Application of International Application No. PCT/JP2018/044753, filed on Dec. 5, 2018, and claims priority to Japanese Patent Application No. 2017-245605, filed on Dec. 21, 2017. The entire disclosures of the above applications are expressly incorporated herein by reference.

### BACKGROUND

### Technical Field

This invention relates to a particle mixture. It also relates to a method for improving light scattering properties using the particle mixture and a light diffusing element and an optical device containing rare earth phosphate particles.

### Related Art

A light-diffusing sheet made of a transparent resin matrix containing light-scattering particles is used in various optical devices, such as LCD backlight modules in TV sets and smartphones, screens of image displays (e.g., rear-projection screens), transparent screens for head-up displays and projectors, sealants in LED devices and μLED devices, and covers in lighting fittings. A light-diffusing sheet in these applications is required to have excellent light scattering properties while securing transparency. A wide viewing angle is also required of a light-diffusing sheet. In view of these requirements, examples of useful light-scattering particles include titania, silica, zirconia, barium titanate, zinc oxide, and resin particles. For example, JP 2010-138270A proposes use of zinc oxide as light-scattering particles.

A light-diffusing sheet containing the light-scattering particles proposed in JP 2010-138270A has transparency and light-scattering properties. When actually applied to a display, however, the light-diffusing sheet cannot be said to have sufficient light-scattering properties to provide a clear image, leaving room for improvement. There is also room for improvement in terms of viewing angle.

An object of the invention is to provide particles that are capable of not only improving light-scattering properties while securing transparency of the substrate but also securing a wide viewing angle when placed inside or on the surface of a substrate.

### SUMMARY

The invention has accomplished the above object by providing a particle mixture containing a particle A and a particle B different from the particle A. The particle A is a particle of a rare earth phosphate represented by LnPO₄ where Ln represents at least one rare earth element selected from the group consisting of Sc, Y, La, Eu, Gd, Dy, Yb, and Lu. The particle B is a particle of a rare earth phosphate represented by LnPO₄ where Ln represents at least one rare earth element selected from the group consisting of Sc, Y, La, Eu, Gd, Dy, Yb, and Lu, or a rare earth titanate particle.

The invention also provides a method for improving light-scattering properties of a substrate. The method includes incorporating the particle mixture to the substrate or placing the particle mixture on the surface of the substrate.

The invention also provides a light-diffusing element including a resin composition containing the particle mixture and a resin, and an optical device having the light-diffusing element.

### BRIEF DESCRIPTION OF THE DRAWINGS

FIG. 1A and FIG. 1B each illustrate the method for measuring luminance of a light-diffusing sheet. FIG. 1A is a schematic side view, and FIG. 1B is a schematic top view.

### DESCRIPTION OF EMBODIMENTS

The invention will be described on the basis of its preferred embodiments. The invention relates to a particle mixture containing at least two types of particles: particle A and particle B, which are different from each other. As used herein, the phrase “different (from each other)” means being different in composition of substances constituting the individual particles. The particle mixture has the form of powder or slurry in a liquid medium, for example. The particle mixture is to be disposed inside or on the surface of a transparent substrate and used to cause light scatter. Specifically, the particle mixture of the invention is placed inside a substrate in a uniformly dispersed state, is placed inside a substrate in a concentrated state in one side of the substrate and the vicinity thereof, or dispersed uniformly in a coating layer provided on the surface of a substrate so as to cause incident light on the substrate to scatter. Incident light can generally be scattered forward (forward scatter) and backward (back scatter). With respect to the direction of scatter, the particle mixture of the invention is used to cause either one or both of forward scatter and back scatter. In what follows, the term “scatter” or “scattering” is intended to include both forward scatter and back scatter, and the term “light” refers to light containing rays of the visible wavelength region.

The particles A and B contained in the particle mixture of the invention are as follows.

Particle A:

A particle of a rare earth phosphate represented by LnPO₄ where Ln represents at least one rare earth element selected from the group consisting of Sc, Y, La, Eu, Gd, Dy, Yb, and Lu.

Particle B:

A particle of a rare earth phosphate represented by LnPO₄ where Ln represents at least one rare earth element selected from the group consisting of Sc, Y, La, Eu, Gd, Dy, Yb, and Lu, or a rare earth titanate particle.

The particle mixture of the invention is (i) a powder containing at least two types of particles: particles A of a rare earth phosphate represented by LnPO₄ and particles B of a rare earth phosphate represented by LnPO₄ that are different from the rare earth phosphate particles A, or (ii) a powder containing at least two types of particles: particles A of a rare earth phosphate represented by LnPO₄ and rare earth titanate particles B. In the case of (i), when the particles A and B have only one rare earth element each, Ln of the particles A and Ln of the particles B are not the same element. In the case of (i), when the particles A and/or the particles B have two or more rare earth elements, the particle A and the particle B differ in type or proportion of Ln. For instance, when particle A and particle B are YₓGd₍₁₋ₓ₎PO₄ and YPO₄, respectively, the particle A and the particle B are different; and when particle A and particle B are Y_{0.8}Gd_{0.2}PO₄ and Y_{0.5}Gd_{0.5}PO₄, respectively, the particle A and the particle B are different. As used herein, the term “particles” refers to either powder as an aggregate of particles or individual particles constituting the powder, which depends on the context.

Both the particles A and B, which constitute the particle mixture of the invention, are high refractive index materials. Because of this, the particle mixture of the invention distributed inside or on the surface of a substrate causes a large amount of light scattering.

Both the particles A and B generally have high Abbe numbers. As a result of the inventors' researches, it has been revealed that the particles A and B have smaller dependence of refractive index on wavelength than other materials with high Abbe number, such as zirconia. In other words, particles A and B show smaller variability in degree of refraction when incident light containing rays of various wavelengths enters them. Therefore, use of the particle mixture of the invention enables light scatter with good color reproducibility.

In addition to the above, using the particle mixture of the invention containing the particles A and B, which are different from each other, brings about the advantage that a light-diffusing element containing the particle mixture of the invention has a wider viewing angle as compared with the use of the particles A or B alone. Thus, the particle mixture of the invention is an extremely excellent material that achieves a wide viewing angle as well as high light transmitting and scattering properties.

The shape of the particles A and B is not critical in the invention. As the shape of the individual particles approaches a sphere, isotropic light scattering tends to become dominant, and the dispersibility in the resin composition for forming a resin substrate or the resin composition for forming a surface coating layer of a substrate tends to become better. On the other hand, when individual rare earth phosphate particles have an anisotropic shape, such as a rod-shape, rare earth phosphate particles tend to provide a light-diffusing sheet having excellent transparency as well as light-scattering properties.

With respect to the particle size of the particles A and B, it has been ascertained that the particle mixture of the invention, which contains the particles A and B, having a sharper particle size distribution exhibits higher light-scattering properties. The particle size distribution of the particle mixture can be evaluated using the value D₉₉/D₅₀ as a measure. D₅₀ and D₉₉ mean the particle diameter at 50% and 99%, respectively, in the volume-based cumulative particle size distribution as measured by laser diffraction particle size distribution analysis. As D₉₉/D₅₀ approaches 1, the particle size distribution becomes sharper. The value D₉₉/D₅₀ in the invention is preferably 15 or smaller, more preferably 13 or smaller, even more preferably 11 or smaller, still more preferably 9 or smaller, yet more preferably 8 or smaller.

With a view to ensuring the viewing angle widening effect, the D₅₀ of the particle mixture is preferably 0.1 to 20 μm, more preferably 0.1 to 10 μm, even more preferably 0.1 to 3 μm.

The D₅₀ and D₉₉ of the particle mixture may be determined as follows. The particle mixture is mixed with water and dispersing treatment is performed on the resulting mixture for 1 minute in a common ultrasonic bath. The determination of the particle size is performed using Beckman Coulter Counter LS13 320.

The particles A and B included in the particle mixture of the invention may be either crystalline or amorphous (non-crystalline). In general, particles A and B produced by the method hereinafter described are crystalline. Particles A and B which are crystalline are preferred because high refractive index is provided.

When the particle A is crystalline, the rare earth phosphate LnPO₄ as the particle A preferably has a xenotime structure or a monazite structure with a view to providing a wide viewing angle. With the same view, when the particle B is crystalline, the rare earth phosphate LnPO₄ as the particle B preferably has a xenotime structure or a monazite structure. When the particle B is a rare earth titanate particle, the rare earth titanate is preferably Ln₂Ti₂O₇, where Ln is as defined above, in terms of a wide viewing angle.

With a view to providing a wide viewing angle, the ratio of the total number of moles of the rare earth element(s) contained in the particle A, designated M_{A}, to the total number of moles of the rare earth element(s) contained in the particle B, designated M_{B}, i.e., M_{A}/M_{B} is preferably 0.005 to 200, more preferably 0.01 to 100, even more preferably 0.1 to 10.

A preferred combination of the particles A and B is YPO₄ as particle A and GdPO₄, LaPO₄, or LuPO₄ as particle B in terms of smaller dependence of refractive index on wavelength as well as a wide viewing angle. For the same reason, a combination of GdPO₄ or LaPO₄ as particle A and LaPO₄ or LuPO₄ as particle B is also preferred. A combination of YPO₄ as particle A and Y₂Ti₂O₇, Gd₂Ti₂O₇, Lu₂Ti₂O₇, or La₂Ti₂O₇ as particle B is also preferred.

The particle mixture of the invention, which contains the particles A and B, may further contain one or more of rare earth phosphates and/or rare earth titanates all of which are different from the particles A and B. Where needed, the particle mixture of the invention may contain a solid component and/or a liquid component other than those particles described above.

The particle mixture of the invention preferably has a BET specific surface area of 1 to 100 m²/g, more preferably 3 to 50 m²/g, even more preferably 5 to 30 m²/g, in terms of particle size control. The BET specific surface area can be determined by nitrogen adsorption using, for example, FlowSorb 2300 from Shimadzu Corp. For example, the amount of the sample powder is 0.3 g, and previous degassing is carried out in the atmosphere at 120° C. for 10 minutes.

The BET specific surface area of the particles A of the particle mixture is preferably 1 to 50 m²/g, more preferably 3 to 50 m²/g, even more preferably 5 to 30 m²/g, and that of the particles B of the particle mixture is preferably 3 to 100 m²/g, more preferably 5 to 50 m²/g, even more preferably 10 to 50 m²/g.

The particle mixture of the invention may be treated to have the surface thereof rendered lipophilic to a degree that does not impair the effects of the invention, in order to improve the dispersibility in the resin composition for forming a resin substrate or the resin composition for forming a surface coating layer of a substrate. Such a surface treatment for lipophilicity is exemplified by a treatment with various coupling agents and a treatment with an organic acid, such as a carboxylic acid or a sulfonic acid. Examples of useful coupling agents include organometallic compounds, such as silane, zirconium, titanium, and aluminum coupling agents.

The coupling agents may be used either individually or in combination of two or more thereof. In using a silane coupling agent, the surface of the rare earth phosphate particles and rare earth titanate particles of the particle mixture is coated with a silane compound. The silane compound preferably has a lipophilic group, e.g., a substituted or unsubstituted alkyl group. The alkyl group may be linear or branched. Whether linear or branched, the alkyl group preferably has 1 to 20 carbon atoms for providing good affinity to resins. Examples of the substituent of the substituted alkyl group include amino, vinyl, epoxy, styryl, methacryl, acryl, ureido, mercapto, sulfide, and isocyanate groups. The amount of the silane compound coating the rare earth phosphate particles and rare earth titanate particles which constitute the particle mixture is preferably 0.01 to 200 mass %, more preferably 0.1 to 100 mass % relative to the mass of the particle mixture in view of good affinity to resins.

The carboxylic acid to be used in the surface treatment preferably has a substituted or unsubstituted alkyl group. The alkyl group may be linear or branched. Whether linear or branched, the alkyl group preferably has 1 to 20 carbon atoms for providing good affinity to resins. Examples of the carboxylic acid include butanoic acid, pentanoic acid, hexanoic acid, heptanoic acid, octanoic acid, nonanoic acid, decanoic acid, dodecanoic acid, tetradecanoic acid, pentadecanoic acid, hexadecanoic acid, heptadecanoic acid, cis-9-octadecenoic acid, and cis,cis-9,12-octadecadienoic acid.

The particle mixture of the invention can be added to a resin, or dissolved in an organic solvent to make a dispersion which is mixed with a resin, to provide a resin composition having improved light scattering properties. The resin composition is not particularly limited in the form and may have the form of sheet (film), membrane, powder, pellets (master batch), application liquid (coating), and so forth. A sheet form is advantageous for ease of application to a light-diffusing sheet.

The resin to which the particle mixture of the invention is added is not particularly limited. Any moldable thermoplastic resins, thermosetting resins, and ionizing radiation-curable resins may be used. Thermoplastic resins are preferred for ease of molding into sheet form.

Examples of useful thermoplastic resins include polyolefin resins, such as polyethylene and polypropylene; polyester resins, such as polyethylene terephthalate and polybutylene terephthalate; polycarbonate resins; polyacrylic resins, such as polyacrylic acid and esters thereof and polymethacrylic acid and esters thereof; polyvinyl resins, such as polystyrene and polyvinyl chloride; cellulose resins, such as triacetyl cellulose; and urethane resins, such as polyurethane.

Examples of useful thermosetting resins include silicone resins, phenol resins, urea resins, melamine resins, furan resins, unsaturated polyester resins, epoxy resins, diallyl phthalate resins, guanamines resins, ketone resins, aminoalkyd resins, urethane resins, acrylic resins, and polycarbonate resins.

Examples of useful ionizing radiation-curable resins include photopolymerizable prepolymers that are curable through crosslinking upon irradiation with ionizing radiation such as ultraviolet radiation and electron beams. The photopolymerizable prepolymer is preferably an acrylic prepolymer having at least two acryloyl groups per molecule and forming a three-dimensional network structure upon curing by crosslinking. Examples of such an acrylic prepolymer include urethane acrylates, polyester acrylates, epoxy acrylates, melamine acrylates, polyfluoroalkyl acrylates, and silicone acrylates. The acrylic prepolymer may be used alone but is preferably combined with a photopolymerizable monomer so as to improve crosslinking curability thereby to form a light-diffusing layer with improved hardness.

Examples of the photopolymerizable monomer include monofunctional acrylic monomers, such as 2-ethylhexyl acrylate, 2-hydroxyethyl acrylate, 2-hydroxypropyl acrylate, and butoxyethyl acrylate; bifunctional acrylic monomers, such as 1,6-hexanediol diacrylate, neopentyl glycol diacrylate, diethylene glycol diacrylate, polyethylene glycol diacrylate, and hydroxypivalic ester neopentyl glycol diacrylate; and polyfunctional acrylic monomers, such as dipentaerythritol hexaacrylate, trimethylpropane triacrylate, and pentaerythritol triacrylate. They may be used either individually or in combination of two or more thereof.

When the photopolymerizable prepolymer is cured by irradiation with ultraviolet radiation, the prepolymer is preferably combined with an additive, such as a photopolymerization initiator or a photopolymerization accelerator, as well as with the photopolymerizable monomer.

Examples of useful photopolymerizable initiator include acetophenones, benzophenones, Michler's ketone, benzoins, benzyl methyl ketals, benzoyl benzoates, α-acyloxime esters, and thioxanthones.

The photopolymerization accelerator is used to reduce the polymerization inhibition by air during the curing reaction thereby to accelerate the curing rate. Examples of the photopolymerization accelerator include isoamyl p-dimethylaminobenzoate and ethyl p-dimethylaminobenzoate.

In the light-diffusing element having a portion formed of a resin composition containing the particle mixture of the invention and a resin, the proportion of the particle mixture is preferably such that the thickness T (μm) of a light-diffusing layer and the concentration C (mass %) of the particle mixture in the light-diffusing layer satisfies relation (I) below in view of the balance between light transmitting properties and light scattering properties.

5≤(T×C)≤500 (I)

When the light-diffusing element is a light-diffusing sheet made of the resin composition, the “thickness” of a light-diffusing layer refers to the thickness of the sheet, or when the light-diffusing element is composed of a substrate and a surface coating layer made of the resin composition, the “thickness” of a light-diffusing layer refers to the thickness of the surface coating layer. It is more preferred for T and C to satisfy relation (II):

10≤(T×C)≤100 (II)

In the light-diffusing element having a portion made of a resin composition containing the particle mixture of the invention and a resin, the thickness of the light-diffusing layer is preferably 2 to 10,000 μm in view of light-scattering properties and handling properties.

The light-diffusing element of such a type as a light-diffusing sheet made of a resin composition containing the particle mixture of the invention and a transparent resin may be produced by, for example, mixing the particle mixture of the invention into a molten resin, and molding the resulting mixture into sheet form by any known techniques for producing sheet, such as blown film extrusion, T-die extrusion, solution casting, and calendering. The light-diffusing element of such a type as a light-diffusing sheet having the particle mixture of the invention placed on the surface of a transparent sheet substrate may be obtained by, for example, mixing the particle mixture of the invention with an organic solvent and a binder resin to prepare a coating liquid, and applying the coating liquid to a substrate using a bar, a blade, a roller, a spray gun, and so on. The particle mixture of the invention may directly be applied to the resin sheet substrate by spattering deposition or a like technique. As used herein, the term “transparent resin” refers to a resin having permeability to visible light. The light-diffusing sheet thus obtained is suited for use as display members, lighting members, window members, illumination members, light guide panel members, projector screens, transparent screens for head-up displays, sealants for LED devices and μLED devices, agricultural materials, such as a greenhouse material, and the like. The light-diffusing sheet is also useful as incorporated in optical devices, such as liquid crystal TV sets, personal computers, mobile devices (e.g., tablet computers, and smartphones), and lighting fittings.

A preferred method for producing the particle mixture of the invention will then be described. The particle mixture of the invention is produced by preparing particles A and particles B and uniformly mixing them using a known mixing means. At least one type of the particles A and B may have the particle size adjusted prior to the mixing. Particle size adjustment may be achieved using a known grinding means, such as a paint shaker.

The methods for preparing the particles A and B are selected as appropriate to the type of the particles. When the particles A and/or the particles B are rare earth phosphate particles, the following method may be adopted. Specifically, an aqueous solution containing a rare earth element source and an aqueous solution containing a phosphate group are first mixed to form a rare earth phosphate precipitate. For example, an aqueous solution containing a phosphate group is added to an aqueous solution containing a rare earth element source to form a rare earth phosphate precipitate. Then, the precipitate is collected by a liquid-solid separation means, dried, and fired to give rare earth phosphate particles. In an example of the preferred method, the collected precipitate is dried by, for example, spray drying and then fired to yield particles of desired shape.

The step of forming a rare earth phosphate precipitate is preferably carried out while heating. On this occasion, the aqueous solution containing a rare earth element source is preferably heated to 50° to 100° C., more preferably 70° to 95° C. By allowing the reaction to occur while heating the system at a temperature in that range, rare earth phosphate particles with a desired D₅₀ and a desired specific surface area are obtained.

The aqueous solution containing a rare earth element source preferably has a rare earth element concentration of 0.01 to 2.0 mol/L, more preferably 0.01 to 1.5 mol/L, even more preferably 0.01 to 1.0 mol/L. It is preferred that the rare earth element be present in the aqueous solution in the form of a trivalent ion or a complex ion of the trivalent ion and one or more ligands. The aqueous solution containing a rare earth element source is prepared by dissolving a rare earth oxide (e.g., Ln₂O₃) in, e.g., a nitric acid aqueous solution.

The aqueous solution containing a phosphate group preferably has a total concentration of phosphoric acid chemical species of 0.01 to 5 mol/L, more preferably 0.01 to 3 mol/L, even more preferably 0.01 to 1 mol/L. An alkali species may be added for pH adjustment. As an alkali species, basic compounds, such as ammonia, ammonium hydrogen carbonate, ammonium carbonate, sodium hydrogen carbonate, sodium carbonate, ethylamine, propylamine, sodium hydroxide, and potassium hydroxide, may be used.

In view of forming the precipitated product efficiently, the mixing ratio of the rare earth element source-containing aqueous solution and the phosphate group-containing aqueous solution is preferably such that the molar ratio of phosphate ion to rare earth ion is 0.5 to 10, more preferably 1 to 10, even more preferably 1 to 5.

The thus formed rare earth phosphate particles are separated from the liquid medium in a usual manner, followed by washing with water at least once. Washing is preferably repeated until the conductivity of the washing filtrate decreases to, for example, 2000 μS/cm or lower.

The step of firing the rare earth phosphate precipitate may be carried out in an oxygen-containing atmosphere, such as air. In this case, the firing temperature is preferably 80° to 1500° C., more preferably 400° to 1300° C. Rare earth phosphate particles having a desired crystal structure and a desired specific surface area can be obtained easily by adopting the above temperature range. If the firing temperature is excessively high, it tends to result that sintering proceeds to increase the crystallinity of the particles and that the specific surface area decreases. The firing time is preferably 1 to 20 hours, more preferably 1 to 10 hours, provided that the firing temperature is in the above range.

The above is a preferred method for producing rare earth phosphate particles. The following is a preferred method for producing rare earth titanate particles, another type of the particles that can be used in the invention. Specifically, an aqueous solution containing a rare earth element source and a titanium source and an aqueous solution containing an acid or an alkali are first poured in a container simultaneously to form a rare earth titanate precursor. Next, the precursor is fired to yield desired rare earth titanate particles. The aqueous solution containing a rare earth element source and a titanium source is prepared by, for example, adding to and dissolving in an aqueous acidic solution (e.g., a hydrochloric acid or nitric acid aqueous solution) a rare earth oxide (e.g., Ln₂O₃) as a rare earth element source and further adding titanium sulfate or titanium tetrachloride as a titanium source. Examples of the acid include mineral acids, such as hydrochloric acid, nitric acid, and sulfuric acid; and carboxylic acids, such as acetic acid and propionic acid. Examples of the alkali include ammonia, ammonium hydrogen carbonate, ammonium carbonate, sodium hydrogen carbonate, sodium carbonate, ethylamine, propylamine, sodium hydroxide, and potassium hydroxide. The firing may be carried out in an oxygen-containing atmosphere, such as air. In that case, the firing temperature is preferably 600° to 1400° C., more preferably 600° to 1200° C. For further details of the preferred method for preparing rare earth titanates, reference can be made, e.g., to JP 2015-67469A.

### EXAMPLES

The invention will now be illustrated by way of Examples, but it should be understood that the invention is not limited thereto. Unless otherwise noted, all the percentages are by mass.

### Example 1

(1) Preparation of Particles A (Yttrium Phosphate Particles)

Water weighing 600 g was put in a glass container (glass container 1), and 61.7 g of 60% nitric acid (from Wako Pure Chemical Ind., Ltd.) and 18.8 g of Y₂O₃ (from Nippon Yttrium Co., Ltd.) were added thereto, followed by heating to 80° C. to prepare an aqueous solution. Separately, water weighing 600 g was put in another glass container (glass container 2), and 18.8 g of 85% phosphoric acid was added thereto.

The contents of the glass container 2 was poured into the glass container 1, followed by aging for 1 hour. The precipitate thus formed was washed by decantation until the conductivity of the supernatant liquid decreased to 100 μS/cm or lower. After the washing, the solid was collected by filtration under reduced pressure, dried in the atmosphere at 120° C. for 5 hours, and fired in the atmosphere at 900° C. for 3 hours to give rare earth phosphate particles A (yttrium phosphate particles). As a result of XRD analysis, the resulting yttrium phosphate particles were found to have a xenotime crystal structure.

(2) Preparation of Particles B (Gadolinium Phosphate Particles)

Water weighing 600 g was put in a glass container (glass container 1), and 61.7 g of 60% nitric acid (from Wako Pure Chemical Ind., Ltd.) and 29.6 g of Gd₂O₃ (from Nippon Yttrium Co., Ltd.) were added thereto, followed by heating to 80° C. to prepare an aqueous solution. Separately, water weighing 600 g was put in another glass container (glass container 2), and 18.8 g of 85% phosphoric acid was added thereto. Thereafter, the same procedure as for the preparation of the particles A was followed to yield rare earth phosphate particles B (gadolinium phosphate particles). The resulting rare earth phosphate particles B (gadolinium phosphate particles) were ground in a paint shaker to adjust the BET specific surface area (and particle size). As a result of XRD analysis, the resulting gadolinium phosphate particles were found to have a monazite crystal structure.

(3) Preparation of Particle Mixture

A 0.5 g portion of the particles A and a 1.0 g portion of the particles B were mixed thoroughly in a mortar to prepare a particle mixture. The mixing ratio of the particles A to the particles B, as expressed in terms of the ratio of the total number of moles of the rare earth element contained in the particle A, M_{A}, to the total number of moles of the rare earth element contained in the particle B, M_{B}, (i.e., M_{A}/M_{B}) is shown in Table 1 below.

(4) Making of Light-Diffusing Sheet

A polycarbonate resin was used as a resin matrix. The resin and the particle mixture were premixed and extrusion molded into a light-diffusing sheet measuring 100 mm×100 mm×1 mm (t). The mixing ratio of the particle mixture to the resin was as shown in Table 1.

### Examples 2 and 3

A particle mixture and a light-diffusing sheet were made in the same manner as in Example 1, except for changing the mixing ratio (molar ratio) of the particles A to the particles B and the mixing ratio of the particle mixture to the resin as shown in Table 1.

### Example 4

A particle mixture and a light-diffusing sheet were made in the same manner as in Example 1, except for replacing GdPO₄ with LaPO₄ and changing the mixing ratio (molar ratio) of the particles A to the particles B and the mixing ratio of the particle mixture to the resin as shown in Table 1. LaPO₄ was prepared as follows.

Preparation of Particles B (Lanthanum Phosphate Particles)

Water weighing 600 g was put in a glass container (glass container 1), and 61.7 g of 60% nitric acid (from Wako Pure Chemical Ind., Ltd.) and 27.1 g of La₂O₃ (from Nippon Yttrium Co., Ltd.) were added thereto, followed by heating to 80° C. to prepare an aqueous solution. Separately, water weighing 600 g was put in another glass container (glass container 2), and 18.8 g of 85% phosphoric acid was added thereto. Thereafter, the same procedure as for the preparation of the particles A in Example 1 was followed to yield rare earth phosphate particles B (lanthanum phosphate particles). The resulting rare earth phosphate particles B (lanthanum phosphate particles) were ground in a paint shaker to adjust the BET specific surface area (and particle size). As a result of XRD analysis, the resulting lanthanum phosphate particles were found to have a monazite crystal structure.

### Example 5

A particle mixture and a light-diffusing sheet were made in the same manner as in Example 1, except for replacing GdPO₄ with LuPO₄ and changing the mixing ratio (molar ratio) of the particles A to the particles B and the mixing ratio of the particle mixture to the resin as shown in Table 1. LuPO₄ was prepared as follows.

Preparation of Particles B (Lutetium Phosphate Particles)

Water weighing 600 g was put in a glass container (glass container 1), and 61.7 g of 60% nitric acid (from Wako Pure Chemical Ind., Ltd.) and 33.1 g of Lu₂O₃ (from Nippon Yttrium Co., Ltd.) were added thereto, followed by heating to 80° C. to prepare an aqueous solution. Separately, water weighing 600 g was put in another glass container (glass container 2), and 18.8 g of 85% phosphoric acid was added thereto. Thereafter, the same procedure as for the preparation of the particles A in Example 1 was followed to yield rare earth phosphate particles B (lutetium phosphate particles). The resulting rare earth phosphate particles B (lutetium phosphate particles) were ground in a paint shaker to adjust the BET specific surface area (and particle size). As a result of XRD analysis, the resulting lutetium phosphate particles were found to have a xenotime crystal structure.

### Example 6

A particle mixture and a light-diffusing sheet were made in the same manner as in Example 4, except for replacing YPO₄ with GdPO₄ and changing the mixing ratio (molar ratio) of the particles A to the particles B and the mixing ratio of the particle mixture to the resin as shown in Table 1. The GdPO₄ used here was prepared in the same manner as for the preparation of the particles B in Example 1, except for adjusting the BET specific surface area as shown in Table 1.

### Example 7

A particle mixture and a light-diffusing sheet were made in the same manner as in Example 5, except for replacing YPO₄ with LaPO₄ and changing the mixing ratio (molar ratio) of the particles A to the particles B and the mixing ratio of the particle mixture to the resin as shown in Table 1. The GdPO₄ used here was prepared in the same manner as for the preparation of the particles B in Example 4, except for adjusting the BET specific surface area as shown in Table 1.

### Example 8

A particle mixture and a light-diffusing sheet were made in the same manner as in Example 1, except for replacing GdPO₄ with Lu₂Ti₂O₇ and changing the mixing ratio (molar ratio) of the particles A to the particles B and the mixing ratio of the particle mixture to the resin as shown in Table 1. Lu₂Ti₂O₇ was prepared as follows.

Preparation of Lutetium Titanate

Water weighing 845.4 g was put in a glass container (glass container 1), and 35.68 g of Lu₂O₃ (from Nippon Yttrium Co., Ltd.), 53.55 g of a TiCl₄ solution (CAS No. 7550-45-0, from Wako Pure Chemical), and 65.37 g of 35% hydrochloric acid (from Wako Pure Chemical) were added thereto and dissolved therein. Separately, water weighing 3955 g was put in another glass container (glass container 2), and 45 g of sodium hydroxide (from Wako Pure Chemical) was added thereto.

The solutions in the containers 1 and 2 were each stirred at room temperature, and simultaneously fed to a homogenizer as a high-shear mixing device operating at 20,000 rpm using a delivery pump at a rate of 10 ml/min and 40 ml/min, respectively, to mix them together in the homogenizer thereby to prepare a slurry of a lutetium titanate precursor. The resulting slurry had a pH of 8.0. The slurry was repulped with pure water until the conductivity of the supernatant liquid decreased to 100 μS/cm or lower. After the repulping, the solid was collected by filtration, and the resulting filter cake was dried at 120° C. for 6 hours, and fired in the atmosphere at 800° C. for 3 hours to give lutetium titanate particles. The lutetium titanate particles were ground in a paint shaker to adjust the BET specific surface area (and particle size). As a result of XRD analysis, the resulting lutetium titanate particles were identified to be crystalline lutetium titanate represented by Lu₂Ti₂O₇.

### Example 9

A particle mixture and a light-diffusing sheet were made in the same manner as in Example 1, except for replacing GdPO₄ with La₂Ti₂O₇ and changing the mixing ratio (molar ratio) of the particles A to the particles B and the mixing ratio of the particle mixture to the resin as shown in Table 1. La₂Ti₂O₇ was prepared as follows.

Preparation of Lanthanum Titanate

Water weighing 852.7 g was put in a glass container (glass container 1), and 28.33 g of La₂O₃ (from Nippon Yttrium Co., Ltd.), 53.55 g of a TiCl₄ solution (CAS No. 7550-45-0, from Wako Pure Chemical), and 65.37 g of 35% hydrochloric acid (from Wako Pure Chemical) were added thereto and dissolved therein. Thereafter, the same procedure as for the preparation of lutetium titanate in Example 8 was followed to yield lanthanum titanate particles. As a result of XRD analysis, the resulting lanthanum titanate particles were identified to be crystalline lanthanum titanate represented by La₂Ti₂O₇.

### Example 10

A particle mixture and a light-diffusing sheet were made in the same manner as in Example 1, except for replacing GdPO₄ with Gd₂Ti₂O₇ and changing the mixing ratio (molar ratio) of the particles A to the particles B and the mixing ratio of the particle mixture to the resin as shown in Table 1. Gd₂Ti₂O₇ was prepared as follows.

Preparation of Gadolinium Titanate

Water weighing 848.5 g was put in a glass container (glass container 1), and 32.53 g of Gd₂O₃ (from Nippon Yttrium Co., Ltd.), 53.55 g of a TiCl₄ solution (CAS No. 7550-45-0, from Wako Pure Chemical), and 65.37 g of 35% hydrochloric acid (from Wako Pure Chemical) were added thereto and dissolved therein. Thereafter, the same procedure as for the preparation of lutetium titanate in Example 8 was followed to yield gadolinium titanate particles. The resulting gadolinium titanate particles were analyzed by XRD. The XRD pattern, while showing a slight diffraction peak assigned to the crystal structure represented by Gd₂Ti₂O₇, gave confirmation that the particles were substantially amorphous gadolinium titanate.

### Example 11

A particle mixture and a light-diffusing sheet were made in the same manner as in Example 1, except for replacing GdPO₄ with Y₂Ti₂O₇ and changing the mixing ratio (molar ratio) of the particles A to the particles B and the mixing ratio of the particle mixture to the resin as shown in Table 1. Y₂Ti₂O₇ was prepared as follows.

Preparation of Ytterium Titanate

Water weighing 860.8 g was put in a glass container (glass container 1), and 20.25 g of Y₂O₃ (from Nippon Yttrium Co., Ltd.), 53.55 g of a TiCl₄ solution (CAS No. 7550-45-0, from Wako Pure Chemical), and 65.37 g of 35% hydrochloric acid (from Wako Pure Chemical) were added thereto and dissolved therein. Thereafter, the same procedure as for the preparation of lutetium titanate in Example 8 was followed to yield ytterium titanate particles. As a result of XRD analysis, the resulting ytterium titanate particles were identified to be crystalline ytterium titanate represented by Y₂Ti₂O₇.

### Examples 12 and 13

A particle mixture and a light-diffusing sheet were made in the same manner as in Example 1, except for replacing the polycarbonate resin with the resin shown in Table 1 and changing the mixing ratio (molar ratio) of the particles A to the particles B and the mixing ratio of the particle mixture to the resin as shown in Table 1.

### Reference Example 1

Rare earth phosphate particles and a light-diffusing sheet were prepared in the same manner as in Example 1, except for using no GdPO₄ but only YPO₄ as particles A and changing the mixing ratio of the rare earth phosphate particles to the resin as shown in Table 1.

### Reference Example 2

Rare earth phosphate particles and a light-diffusing sheet were prepared in the same manner as in Example 1, except for using no YPO₄ but only GdPO₄ as particles B and changing the mixing ratio of the rare earth phosphate particles to the resin as shown in Table 1.

Evaluation:

The BET specific surface area of the particles A and B for the particle mixture of Examples was measured by the method described above. The BET specific surface area, D₅₀ and D₉₉ of the particle mixtures obtained in Examples and the rare earth phosphate particles used in Reference Examples were measured by the methods described above. The total transmittance, haze, and luminance of the light-diffusing sheets obtained in Examples and Reference Examples were measured by the methods below. The results of the measurements are shown in Table 1.

Measurement of Total Transmittance and Haze:

Measurement was made by using a haze meter NDH 2000 from Nippon Denshoku Industries Co., Ltd.

Evaluation of Viewing Angle:

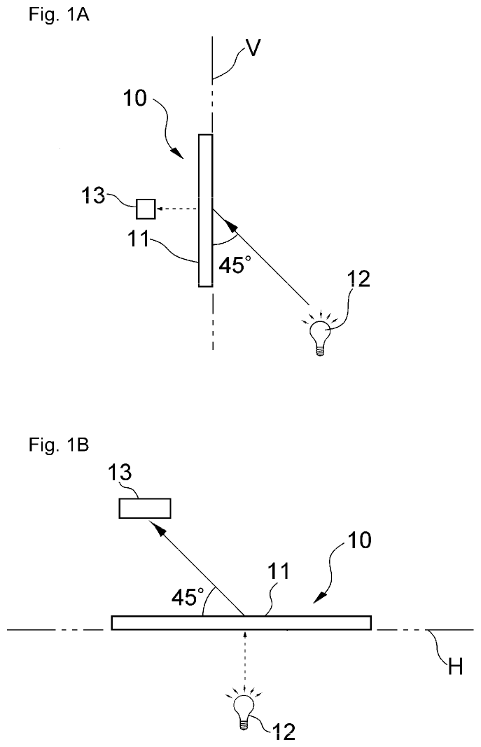

As illustrated in FIG. 1A, a light-diffusing sheet 10 after the measurement of total transmittance was placed along a vertical plane V and irradiated with light using a short focus projector as a light source 12. Light was directed upward to the light-diffusing sheet 10 with an angle of 45° to the vertical plane V. A luminance meter 13 was set on the other side than the light-irradiated side (i.e., the side of the light emitting surface 11 of the light-diffusing sheet 10) to measure the luminance of the light emitted from the light-diffusing sheet 10. As illustrated in FIG. 1B, the luminance meter 13 was placed at an angle of 45° to a line H traversing the light-diffusing sheet 10 in parallel with the horizon. The luminance value of the light-diffusing sheet of each of Examples and Reference Example 2 was divided by that of the light-diffusing sheet of Reference Example 1 to give a luminance ratio, (luminance of the light-diffusing sheet of each Example or Reference Example 2)/(luminance of the light-diffusing sheet of Reference Example 1). In Table 1, “SSA” stands for specific surface area, “PC” stands for polycarbonate, and “PET” stands for polyethylene terephthalate.

TABLE 1

| | Particle A | | | Particle B | | Particle Mixture | | | | | Light-Diffusing Sheet | | | | |
|---|---|---|---|---|---|---|---|---|---|---|---|---|---|---|---|
| | | BET | | | BET | Mixing Ratio | BET | | | | | Particles/ | Total | | Lumin- |
| | | SSA | Crystal | | SSA | Particles A/B | SSA | D₅₀ | D₉₉ | D₉₉/ | | Resin | Transmit- | Haze | ance |
| | Kind | (m²/g) | Structure | Kind | (m²/g) | (by mole) | (m²/g) | (μm) | (μm) | D₅₀ | Resin | (mass %) | tance (%) | (%) | Ratio* |
| Ex. 1 | YPO₄ | 10 | xenotime | GdPO₄ | 22 | 0.7 | 17 | 0.2 | 2.8 | 14.0 | PC | 0.1 | 88.8 | 10.7 | 2.8 |
| Ex. 2 | YPO₄ | 10 | xenotime | GdPO₄ | 22 | 1.4 | 11 | 0.5 | 5.7 | 12.4 | PC | 0.05 | 88.4 | 8.3 | 2.3 |
| Ex. 3 | YPO₄ | 10 | xenotime | GdPO₄ | 22 | 4.1 | 10 | 1.2 | 6.7 | 5.6 | PC | 0.05 | 88.7 | 10.2 | 1.6 |
| Ex. 4 | YPO₄ | 10 | xenotime | LaPO₄ | 14 | 1.3 | 12 | 0.7 | 5.8 | 8.3 | PC | 0.05 | 87.9 | 11.0 | 2.1 |
| Ex. 5 | YPO₄ | 10 | xenotime | LuPO₄ | 15 | 1.5 | 11 | 0.6 | 6.1 | 10.2 | PC | 0.05 | 88.1 | 11.1 | 2.2 |
| Ex. 6 | GdPO₄ | 5.9 | monazite | LaPO₄ | 14 | 0.9 | 10 | 0.5 | 3.7 | 7.4 | PC | 0.05 | 89.7 | 9.5 | 2.7 |
| Ex. 7 | LaPO₄ | 6.8 | monazite | LuPO₄ | 15 | 1.2 | 11 | 0.6 | 2.9 | 4.8 | PC | 0.05 | 88.9 | 9.9 | 2.5 |
| Ex. 8 | YPO₄ | 10 | xenotime | Lu₂Ti₂O₇ | 39 | 1.5 | 12 | 0.7 | 3.4 | 4.9 | PC | 0.01 | 87.9 | 8.3 | 3.2 |
| Ex. 9 | YPO₄ | 10 | xenotime | La₂Ti₂O₇ | 29 | 5.3 | 10 | 0.6 | 2.9 | 4.8 | PC | 0.02 | 88.4 | 9.2 | 3.4 |
| Ex. 10 | YPO₄ | 10 | xenotime | Gd₂Ti₂O₇ | 48 | 3.3 | 11 | 0.6 | 3.8 | 6.3 | PC | 0.02 | 88.0 | 11.9 | 5.1 |
| Ex. 11 | YPO₄ | 10 | xenotime | Y₂Ti₂O₇ | 42 | 2.1 | 12 | 0.7 | 3.0 | 4.3 | PC | 0.01 | 87.6 | 7.0 | 3.2 |
| Ex. 12 | YPO₄ | 10 | xenotime | GdPO₄ | 22 | 0.7 | 17 | 0.2 | 2.8 | 14.0 | acrylic | 0.05 | 88.3 | 12.8 | 3.2 |
| Ex. 13 | YPO₄ | 10 | xenotime | GdPO₄ | 22 | 1.4 | 11 | 0.5 | 5.7 | 12.4 | PET | 0.05 | 88.0 | 10.9 | 2.7 |
| Ref. | YPO₄ | 10 | xenotime | — | — | — | 10 | 1.5 | 6.8 | 4.5 | PC | 0.05 | 89.3 | 10.9 | — |
| Ex. 1 | | | | | | | | | | | | | | | |
| Ref. | — | — | — | GdPO₄ | 22 | — | 22 | 0.2 | 1.1 | 5.5 | PC | 0.05 | 89.6 | 6.1 | 0.9 |
| Ex. 2 | | | | | | | | | | | | | | | |

*Relative to the luminance of Reference Example 1.

As is apparent from the results in Table 1, when the particle mixtures of Examples are used, total light transmittance and haze values comparative to those obtained in using the rare earth phosphate particles of Reference Examples 1 and 2 are obtained. These characteristic values adequately meet the performance requirements of transparent screens and other applications. It has thus been proved that the light-diffusing sheets containing the particle mixtures of Examples and the rare earth phosphate particles of Reference Examples have high transmittance and light scattering properties. Furthermore, as compared with the rare earth phosphate particles of Reference Examples 1 and 2, the particle mixtures of Examples allow for high luminance even when the location of measuring the luminance is away at a large angle from the front direction of the light source. It is seen from this that the light-diffusing sheets including the particle mixtures of Examples have a wider viewing angle than those including the rare earth phosphate particles of Reference Examples when used as a transparent screen and the like.

### INDUSTRIAL APPLICABILITY

The particle mixture of the invention improves light-scattering properties while retaining the transparency of the substrate and securing a wide viewing angle, when placed inside or on the surface of a substrate.

1. A particle mixture comprising
a particle A, and
a particle B different from the particle A,
the particle A being a particle of a rare earth phosphate represented by LnPO₄ wherein Ln represents at least one rare earth element selected from the group consisting of Sc, Y, La, Eu, Gd, Dy, Yb, and Lu, and
the particle B being a particle of a rare earth phosphate represented by LnPO₄ wherein Ln represents at least one rare earth element selected from the group consisting of Sc, Y, La, Eu, Gd, Dy, Yb, and Lu, or a rare earth titanate particle.

2. The particle mixture according to claim 1, wherein the LnPO₄ as the particle A has a xenotime crystal structure or a monazite crystal structure.

3. The particle mixture according to claim 1, wherein the particle A comprises YPO₄, and the particle B comprises at least one of GdPO₄, LaPO₄, and LuPO₄.

4. The particle mixture according to claim 1, wherein the particle A comprises at least one of GdPO₄ and LaPO₄, and the particle B comprises at least one of LaPO₄ and LuPO₄.

5. The particle mixture according to claim 1 wherein the particle B comprises a rare earth titanate represented by Ln₂Ti₂O₇ wherein Ln is as defined above.

6. The particle mixture according to claim 5, wherein the particle A comprises YPO₄, and the particle B comprises at least one of Y₂Ti₂O₇, Gd₂Ti₂O₇, Lu₂Ti₂O₇, and La₂Ti₂O₇.

7. The particle mixture according to claim 1, being placed inside or on the surface of a substrate to cause light scattering.

8. A method for improving light-scattering properties of a substrate, comprising incorporating the particle mixture according to claim 1 into the substrate.

9. A method for improving light-scattering properties of a substrate, comprising placing the particle mixture according to claim 1 on the surface of the substrate.

10. A dispersion comprising the particle mixture according to claim 1 and an organic solvent.

11. A resin composition comprising the particle mixture according to claim 1 and a resin.

12. A light-diffusing element comprising the resin composition according to claim 11.

13. A light-diffusing element, having a light-diffusing layer, the light-diffusing layer comprising:
the resin composition according to claim 11 and having a thickness T (μm) and a rare earth phosphate particle concentration C (mass %), the T and C satisfying relation (I):
5≤(T×C)≤500 (I).

14. An optical device comprising the light-diffusing element according to claim 12.

15. An optical device comprising the light-diffusing element according to claim 13.

16. The particle mixture according to claim 2, wherein the particle A comprises YPO₄, and the particle B comprises at least one of GdPO₄, LaPO₄, and LuPO₄.

17. The particle mixture according to claim 2, wherein the particle A comprises at least one of GdPO₄ and LaPO₄, and the particle B comprises at least one of LaPO₄ and LuPO₄.

18. The particle mixture according to claim 2, wherein the particle B comprises a rare earth titanate represented by Ln₂Ti₂O₇ wherein Ln is as defined above.

19. The particle mixture according to claim 18, wherein the particle A comprises YPO₄, and the particle B comprises at least one of Y₂Ti₂O₇, Gd₂Ti₂O₇, Lu₂Ti₂O₇, and La₂Ti₂O₇.
